(19) United States
(12) Patent Application Publication
(10) Pub. No.: US 2024/0384103 A1
(43) Pub. Date: Nov. 21, 2024

(54) Method of Recovering Inorganic Pigment

(71) Applicant: PRA World Ltd., Leicestershire (GB)

(72) Inventor: Benjamin John NADEN, Nottinghamshire (GB)

(21) Appl. No.: 18/690,066

(22) PCT Filed: Sep. 6, 2022
(86) PCT No.: PCT/GB2022/052267

§ 371 Date: Mar. 7, 2024

(30) Foreign Application Priority Data
Sep. 8, 2021 (GB) 2112761.8

(51) Int. Cl. C09C 1/36; B01D 21/00; B01D 21/01; B01D 21/26; C08K 9/08; C09C 3/00; C09D 7/62

(52) U.S. Cl. CPC C09C 1/3692; B01D 21/0012; B01D 21/01; B01D 21/262; C09C 1/363; C09C 1/3653; C09C 1/3676; C09C 3/003; C09D 7/62; C08K 9/08

(57) ABSTRACT

A method of recovering an inorganic pigment from a coating composition, the method comprising a step of adding polyethylene glycol to the coating composition. The invention also concerns a coating composition comprising an inorganic pigment composition recovered according to the method, and the use of polyethylene glycol in the recovery of inorganic pigment from a coating composition.

### TECHNICAL FIELD OF THE INVENTION

The present invention relates to a method of recovering inorganic pigment. In particular, the invention relates to a method of recovering inorganic pigment from a coating composition using polyethylene glycol. The invention further relates to the use of polyethylene glycol in recovering inorganic pigment from a coating composition, and to a coating composition comprising recovered inorganic pigment.

### BACKGROUND TO THE INVENTION

Over 300 million litres of paint are sold in the United Kingdom each year, with approximately 55 million litres remaining unused, much of which goes to landfill waste. Despite investment in community projects and take-back programmes launched by some paint manufacturers to collect waste paint for reuse and remanufacture, up to 99% of the unused paint still finds its way into waste streams.

Liquid coating compositions, for example architectural coatings, water-borne paints and solvent-borne products, comprise three main components: polymer resins, inorganic and organic pigments, and a liquid carrier. Polymer resins provide the film-forming properties of the paint, adhering to and protecting the underlying substrate. Inorganic and organic pigments provide aesthetic properties and, in some cases, provide additional functionality, for example, in the form of UV protection, and contribute to the finish of the coating composition upon a substrate. The liquid carrier facilitates delivery of the polymer resins and inorganic and organic pigments to a substrate. The polymer resins and inorganic and organic pigments are typically suspended or dissolved in the liquid carrier that is either water or an organic solvent.

Titanium dioxide (TiO₂) is the most common inorganic pigment found in coating compositions because of the opacity, aesthetics, durability of colour and protection properties it confers to the coating composition, and is often used in combination with coloured pigments. Approximately 90% of worldwide TiO₂ production is for use as a pigment in coating compositions. Other mineral pigments are used as fillers and extenders, providing colour and opacity alongside TiO₂ but at reduced cost and efficacy. Carbonates, including calcium carbonate and dolomite, are heavily relied upon as extenders, and these are often accompanied by silicate minerals, including clays (kaolin and calcined clay (metakaolin)), talc, silica and mica.

Cost of manufacture and a high demand for TiO₂ has resulted in a continually increasing price and this, as well as the environmental burden of ilmenite (a significant natural source of TiO₂) extraction and processing for TiO₂ production, means that there are economic and environmental sustainability incentives for identifying alternative sources of TiO₂.

There is also an increase in market demand for waterborne paint which will inevitably result in an increase in waste. This represents a significant raw material resource to support the current reuse and remanufacture schemes in the drive to reduce the need for costly and wasteful disposal.

Known methods of recovering specific components from coating compositions, in particular recovering TiO₂ from waste paint, typically use thermal treatment to heat the coating composition, typically to a temperature of at least 400° C., such that organic components are incinerated, and the liquid carrier evaporates.

Disadvantageously, the conventional methods of recovering pigment from coating compositions result in a mixed-pigment product (i.e. TiO₂ mixed with other inorganic pigments and fillers) which exhibits inferior characteristics compared to corresponding pure, or significantly pure, TiO₂ pigment. The inferior characteristics predominantly result from the presence of other inorganic materials added to the paint composition e.g. fillers, extenders, and pigments other than TiO₂, and from the modification of the inorganic pigment physical properties and surface chemistry due to thermal treatment. Degradation of inorganic pigments, in particular TiO₂, during thermal treatment can be caused by increased particle size, possibly by aggregation or fusing of particles. These changes reduce the specific surface area of the inorganic pigment of interest, for example TiO₂. Further, thermal treatment can affect future applications of any recovered inorganic pigment due to modification of the inorganic pigment surface. This significantly affects the usability, processability and performance of recovered inorganic pigments. Further, the high temperatures employed in thermal treatment cause a change to the crystal morphology of the inorganic pigment. For example, using thermal treatment to recover TiO₂ can convert optimum refractive index rutile TiO₂ to a less efficient anatase morphology which significantly affects the performance of the inorganic pigment in future applications.

At present, there is no commercial technology which can efficiently recover inorganic pigments, for example TiO₂, from coating compositions, and provide a commercially viable recovered pigment product on an industrial scale which does not exhibit reduced, or at least significantly reduced, performance characteristics.

It is an aim of embodiments of the invention to overcome or mitigate at least one problem of the prior art, whether expressly disclosed herein or not.

### SUMMARY OF THE INVENTION

According to a first aspect of the invention, there is provided a method of recovering inorganic pigment from a coating composition, the method comprising a step of:
a. adding polyethylene glycol to the coating composition.

Surprisingly, it has been found that the method of the invention advantageously provides a reliable and efficient method of recovering inorganic pigment from coating compositions, in particular waste coating compositions, for example waste water-based paint. Beneficially, the method of the invention efficiently separates organic and inorganic components from the coating composition, allowing isolation and recovery of the inorganic pigment which can then be reused for further application, for example as an inorganic pigment in paint products. It has been found that adding polyethylene glycol (PEG) to a coating composition causes flocculation of some inorganic components (for example silicates, including talc and clay that are added to coating compositions as pigments and fillers). The flocculated material may then be separated from a remaining suspension comprising suspended inorganic pigment, for example TiO₂.

It is believed that PEG adsorbs to the coating composition components to be flocculated (for example, inorganic components including inorganic silicate components e.g. talc, clay and other silicate pigments and fillers) via an interaction through a hydrogen bonding mechanism involving isolated surface hydroxyls (Bronsted acid site) of the coating composition components to be flocculated (for example, inorganic components including inorganic silicate components e.g. talc, clay and other silicate pigments and fillers) and an ether-oxygen of the PEG molecule (Lewis base).

Advantageously, the method of the invention allows for recovery of pure, or substantially pure, inorganic pigment, for example TiO₂, from coating compositions, in particular from waste coating compositions. This provides a significant advantage over conventional methods of recovering inorganic pigment which typically rely on thermal treatment. Such conventional methods recover a mixed-pigment product which requires significant further processing, adding to cost and environmental impact, to obtain an inorganic pigment of sufficient purity that can be reused.

Further, the method of the invention does not use thermal treatment to recover inorganic pigment. By ‘thermal treatment’, we mean heating the coating composition to a temperature sufficient to incinerate the organic components (typically, a temperature of at least 400° C.). As such, in comparison to conventional methods, inorganic pigment recovered using the method of the invention does not exhibit a reduced specific surface area, an increase in inorganic pigment particle size, modifications to inorganic pigment surface chemistry or a change to the crystal morphology of the inorganic pigment. It follows that inorganic pigment recovered using the method of the invention does not exhibit reduced, or at least significantly reduced, performance characteristics. Furthermore, the method of the invention enables the separation of inorganic pigments used in paint composition, by selective flocculation of certain suspended inorganic pigment particles (silicates including clay and talc) which can then be removed by filtration, centrifugation, or by decanting. The method of the invention, therefore, provides for viable and commercial recovery of inorganic pigment, in particular TiO₂, from coating compositions on an industrial scale.

A recovered inorganic pigment composition, for example a composition comprising TiO₂, may then be used as an additive to a new coating composition comprising polymer resin(s), organic pigment(s) and a liquid carrier. As such, the recovered inorganic pigment composition can be utilised as a source of inorganic pigment either as a sole source of inorganic pigment for the new coating composition or as one of multiple sources of inorganic pigment for the new coating composition. The inorganic pigment composition may be treated by milling or dispersing in a dispersing medium as is conventional in preparing additions of inorganic pigments to coating compositions. Post-processing of the inorganic pigment composition, such as by milling or dispersing in a dispersing medium, may enhance the performance properties (for example, optical properties including gloss and/or tint strength) of the coating composition into which the inorganic pigment composition is added. To the extent that the inorganic pigment composition includes other components such as alumina or the like, it will be appreciated that those other components need to be accounted for when formulating a new coating composition.

Further advantageously, the method of the invention provides for cost effective recovery of inorganic pigment, for example TiO₂, compared to the cost of ilmenite extraction and processing for TiO₂ production. As such, the method of the invention provides an economically advantageous alternative to inorganic pigment, in particular TiO₂, production from natural sources.

Even further advantageously, the method of the invention promotes, and allows for, the recycling of waste coating compositions. The invention, therefore, provides an environmentally friendly alternative to conventional inorganic pigment production methods, in particular ilmenite extraction and processing to obtain TiO₂, and provides for recycling of substantial volumes of waste materials in support of community projects and take-back initiatives.

Moreover, the present invention is an improvement on the conventional methods of recovering specific components from coating compositions which rely on thermal treatment which is expensive and must be carefully controlled. Comparably, the method of the invention uses PEG which is cheap to obtain and provides no significant difficulty in handling or processing.

The method may further comprise a step of washing the coating composition with an acid before step (a), to obtain an acid-washed coating composition.

Coating compositions typically comprise carbonates, for example calcium carbonate, as an extender. It has been found that the presence of carbonates is detrimental to the efficacy of flocculation of inorganic components (for example inorganic silicate components e.g. talc and clay) in coating compositions using PEG. As such, the presence of carbonates in a coating composition may affect the efficacy of recovery of inorganic pigment using PEG. Advantageously, washing the coating composition with an acid before step (a), i.e. before adding PEG, removes any carbonates present in the coating composition by converting them into carbon dioxide and water. It follows that the acid-washed coating composition is free of carbonates which cannot, therefore, affect the efficiency of flocculation of organic components and silicate minerals in coating compositions using PEG.

The acid may be hydrochloric acid, nitric acid, hydrobromic acid, hydroiodic acid, perchloric acid, chloric acid, sulphuric acid, hydrofluoric acid, or a mixture thereof. Preferably, the acid is hydrochloric acid. Beneficially, each of hydrochloric acid and sulphuric acid are strong acids that are relatively cheap and readily available.

The acid may be present in an amount of between about 0.01 and about 10 mol/L of coating composition.

The acid may be present in an amount of no more than about 0.01 mol/L of coating composition, about 0.05 mol/L, 0.1 mol/L, about 0.2 mol/L, about 0.3 mol/L, about 0.4 mol/L, about 0.5 mol/L, about 0.6 mol/L, about 0.7 mol/L, about 0.8 mol/L, about 0.9 mol/L, about 1.0 mol/L, about 1.2 mol/L, about 1.4 mol/L, about 1.6 mol/L, about 1.8 mol/L, about 2.0 mol/L, about 2.2 mol/L, about 2.4 mol/L, about 2.6 mol/L, about 2.8 mol/L, about 3.0 mol/L, about 3.2 mol/L, about 3.4 mol/L, about 3.6 mol/L, about 3.8 mol/L, about 4.0 mol/L, about 4.2 mol/L, about 4.4 mol/L, about 4.6 mol/L, about 4.8 mol/L, about 5.0 mol/L, about 5.2 mol/L, about 5.4 mol/L, about 5.6 mol/L, about 5.8 mol/L, about 6.0 mol/L, about 6.2 mol/L, about 6.4 mol/L, about 6.6 mol/L, about 6.8 mol/L, about 7.0 mol/L, about 7.2 mol/L, about 7.4 mol/L, about 7.6 mol/L, about 7.8 mol/L, about 8.0 mol/L, about 8.2 mol/L, about 8.4 mol/L, about 8.6 mol/L, about 8.8 mol/L, about 9.0 mol/L, about 9.2 mol/L, about 9.4 mol/L, about 9.6 mol/L, about 9.8 mol/L, or no more than about 10.0 mol/L of coating composition.

The acid may be present in an amount of at least about 0.01 mol/L of coating composition, about 0.05 mol/L, about 0.1 mol/L, about 0.2 mol/L, about 0.3 mol/L, about 0.4 mol/L, about 0.5 mol/L, about 0.6 mol/L, about 0.7 mol/L, about 0.8 mol/L, about 0.9 mol/L, about 1.0 mol/L, about 1.2 mol/L, about 1.4 mol/L, about 1.6 mol/L, about 1.8 mol/L, about 2.0 mol/L, about 2.2 mol/L, about 2.4 mol/L, about 2.6 mol/L, about 2.8 mol/L, about 3.0 mol/L, about 3.2 mol/L, about 3.4 mol/L, about 3.6 mol/L, about 3.8 mol/L, about 4.0 mol/L, about 4.2 mol/L, about 4.4 mol/L, about 4.6 mol/L, about 4.8 mol/L, about 5.0 mol/L, about 5.2 mol/L, about 5.4 mol/L, about 5.6 mol/L, about 5.8 mol/L, about 6.0 mol/L, about 6.2 mol/L, about 6.4 mol/L, about 6.6 mol/L, about 6.8 mol/L, about 7.0 mol/L, about 7.2 mol/L, about 7.4 mol/L, about 7.6 mol/L, about 7.8 mol/L, about 8.0 mol/L, about 8.2 mol/L, about 8.4 mol/L, about 8.6 mol/L, about 8.8 mol/L, about 9.0 mol/L, about 9.2 mol/L, about 9.4 mol/L, about 9.6 mol/L, about 9.8 mol/L, or at least about 10.0 mol/L of coating composition.

The step of washing the coating composition with acid may be carried out at a temperature of between about 10 and about 100° C., between about 15 and about 100° C., between about 20 and about 100° C., between about 25 and about 95° C., between about 25 and about 90° C., between about 25 and about 85° C., between about 25 and about 80° C., between about 30 and about 75° C., between about 30 and about 70° C., between about 30 and about 65° C., between about 30 and about 60° C., between about 35 and about 55° C., between about 40 and about 50° C., or about 45° C.

The step of washing the coating composition with acid may be carried out at a temperature of at least about 10° C., about 15° C., about 20° C., about 25° C., about 30° C., about 35° C., about 40° C., about 45° C., about 55° C., about 60° C., about 65° C., about 70° C., about 75° C., about 80° C., about 85° C., about 90° C., about 95° C., or at least about 100° C.

The step of washing the coating composition with acid may be carried out at a temperature of no more than about 10° C., about 15° C., about 20° C., about 25° C., about 30° C., about 35° C., about 40° C., about 45° C., about 55° C., about 60° C., about 65° C., about 70° C., about 75° C., about 80° C., about 85° C., about 90° C., about 95° C., or no more than about 100° C.

Advantageously, heating the coating composition and acid during the washing step accelerates the rate of reaction between the acid and any carbonates present in the coating composition, therefore decreasing the overall method time.

The step of washing the coating composition with acid may be carried out under agitation of the coating composition and acid. The coating composition and the acid may be agitated by stirring. Suitable methods of stirring may include magnetic stirrer, blade stirrer, propellor stirrer, turbine stirrer, anchor stirrer, paddle stirrer, high shear stirrer, rotor-stator mixer, dual asymmetric centrifuge, rotating mixer, ultrasonic mixer, tank pump circulation, jet mixer, rocking, shaking. Beneficially, agitation of the coating composition and acid accelerates the reaction between the acid and any carbonates present in the coating composition. Thus, agitation of the coating composition and acid decreases the overall method time.

The method may further comprise, before step (a), a step of washing the coating composition or acid-washed coating composition with water by centrifuge or filtration until a supernatant or filtrate is obtained having a less than 500 μS, less than 450 μS, less than 400 μS, less than 350 μS, less than 300 μS, less than 250 μS, less than 200 μS, less than 150 μS, less than 100 μS, less then 90 μS, less than 80 μS, less than 70 μS, less than 60 μS, less than 50 μS, less than 40 μS, less than 30 μS, less than 25 μS, less than 20 μS, or less than 15 μS, as measured by an electrical conductivity meter.

Advantageously, adjusting the conductivity to less than 500 μS ensures than the supernatant or filtrate is suitable for future application, such as for use in a coating composition.

The method may further comprise, before step (a), a step of adjusting the pH of the coating composition or acid-washed coating composition to between pH 6 and 8, preferably pH 7, with an alkali solution before step (a), to form a coating composition suspension or an acid-washed coating composition suspension.

The alkali solution may be sodium hydroxide or potassium hydroxide, or any other alkali salts.

The alkali solution may be in an amount of between about 0.001 M and about 10 M, between about 0.01 M and about 8 M, between about 0.1 M and about 7 M, between about 0.2 M and about 6 M, between about 0.3 M and about 5 M, between about 0.4 M and about 4 M, between about 0.5 M and about 3 M, between about 0.6 M and about 2 M, between about 0.8 M and about 1.5 M, between about 0.9 M and about 1.1 M, or about 1.0 M.

The method may further comprise, before step (a), a step of initially diluting the coating composition with water to between 99.9% (i.e. about 99.9 g of coating composition to about 0.1 g of water) and about 1% (i.e. about 1 g of coating composition to about 99 g of water) w/w coating composition, between about 90% and about 2% w/w coating composition, between about 80% and about 3% w/w coating composition, between about 70% and about 4% w/w coating composition, between about 60% and about 5% w/w coating composition, between about 50 and about 10% w/w coating composition, between about 40 and about 15% w/w coating composition, between about 30 and about 16% w/w coating composition, between about 25 and about 18% w/w coating composition, between about 22 and about 19% w/w coating composition, or about 20% w/w coating composition based on the weight of the coating composition, to obtain a diluted coating composition, before step (a).

The method may further comprise a step of separating coating composition solids from the diluted coating composition by filtration and/or centrifugation to obtain coating composition solids and a supernatant and/or filtrate, before step (a).

The coating composition solids may be washed with acid before step (a), to obtain the acid-washed coating composition.

Step (a) of the method of the invention may form a suspension and a flocculated material, and the method may further comprise, after step (a):
b. separating the suspension from the flocculated material formed in step (a).

It has been found that the flocculated material comprises the inorganic silicate components (for example, silicates including clay and talc, and fillers) of the coating composition. Moreover, it has been found that the remaining suspension comprises suspended TiO₂ pigment. Advantageously, separating the flocculated material from the remaining suspension separates the inorganic silicate components from the TiO₂ pigment.

The suspension and the flocculated material may be separated by filtration and/or centrifugation and/or decantation.

The flocculated material may be washed to remove remaining PEG and the inorganic silicate components comprised therein may be reused as an extender and/or filler in subsequent coating compositions. Beneficially, the method of the invention allows recycling of the platy materials of the coating composition which reduces the cost and environmental impact of manufacturing further coating compositions.

The method of the invention may further comprise, after step (b):
c. concentrating the suspension to increase the solids content thereof.

The suspension may be concentrated by filtration, centrifugation, decantation, dehydration and/or evaporation to obtain a substantially solid inorganic pigment component.

The substantially solid inorganic pigment component may be dried. Drying may be carried out at a temperature above water boiling point e.g., at 105° C., 110° C., 115° C. or 120° C., for a period of time sufficient to remove any water present, that is until there is no further reduction in mass. Reduced pressure may be used to reduce drying temperature and/or time.

The suspension separated in step (b) may comprise the inorganic pigment, or a portion thereof.

The polyethylene glycol may have a molecular weight of between about 4,000,000 g/mol and about 10,000,000 g/mol, between about 5,000,000 g/mol and about 9,500,000 g/mol, between about 6,000,000 g/mol and about 9,500,000 g/mol, between about 7,000,000 g/mol and about 9,000,000 g/mol, between about 7,500,000 g/mol and about 8,500,000 g/mol, or about 8,000,000 g/mol.

The polyethylene glycol may have a molecular weight of at least 4,000,000 g/mol, 4,500,000 g/mol, 5,000,000 g/mol, 5,500,000 g/mol, 6,000,000 g/mol, 6,500,000 g/mol, 7,000,000 g/mol, 7,500,000 g/mol, 8,000,000 g/mol, 8,500,000 g/mol, 9,000,000 g/mol, 9,500,000 g/mol, 10,000,000 g/mol, 10,500,000 g/mol, 11,000,000 g/mol, 11,500,000 g/mol, 12,000,000 g/mol, 12,500,000 g/mol, 13,000,000 g/mol, 13,500,000 g/mol, 14,000,000 g/mol, 14,500,000 g/mol, 15,000,000 g/mol, 15,500,000 g/mol, 16,000,000 g/mol, 16,500,000 g/mol, 17,000,000 g/mol, 17,500,000 g/mol, 18,000,000 g/mol, 18,500,000 g/mol, 19,000,000 g/mol, 19,500,000 g/mol, or at least 20,000,000 g/mol.

The polyethylene glycol may have a molecular weight of no more than 20,000,000 g/mol, 19,500,000 g/mol, 19,000,000 g/mol, 18,500,000 g/mol, 18,000,000 g/mol, 17,500,000 g/mol, 17,000,000 g/mol, 16,500,000 g/mol, 16,000,000 g/mol, 15,500,000 g/mol, 15,000,000 g/mol, 14,500,000 g/mol, 14,000,000 g/mol, 13,500,000 g/mol, 13,000,000 g/mol, 12,500,000 g/mol, 12,000,000 g/mol, 11,500,000 g/mol, 11,000,000 g/mol, 10,500,000 g/mol, 10,000,000 g/mol, 9,500,000 g/mol, 9,000,000 g/mol, 8,500,000 g/mol, 8,000,000 g/mol, 7,500,000 g/mol, 7,000,000 g/mol, 6,500,000 g/mol, 6,000,000 g/mol, 5,500,000 g/mol, 5,000,000 g/mol, 4,500,000 g/mol, or no more than 4,000,000 g/mol.

The polyethylene glycol may be in the form of a solution having a polyethylene glycol concentration in the diluted coating composition of between about 0.001 and about 2.0 g/L, between about 0.002 and about 1.0g/L, between about 0.003 and about 0.5 g/L, between about 0.01 and about 0.1 g/L, between about 0.014 and about 0.05 g/L, between about 0.015 and about 0.02 g/L, or about 0.016 g/L.

The inorganic pigment may be titanium dioxide.

The coating composition may be selected from the group comprising a paint, including water-borne paint and/or solvent-borne paint, a stain, a varnish, or an ink.

The coating composition may comprise any number of different or the same coating compositions. For example, the coating composition may comprise a mixture of waste paints or a mixture of waste paint, varnish and ink.

According to a second aspect of the invention, there is provided a coating composition comprising an inorganic pigment composition recovered according to the method of the first aspect.

The coating composition may be selected from the group comprising a paint, including water-borne paint and/or solvent-borne paint, a stain, a varnish, or an ink.

The inorganic pigment may be titanium dioxide.

The invention according to the second aspect may optionally include any of the optional features of the invention according to the first aspect.

According to a third aspect of the invention, there is provided a use of polyethylene glycol in the recovery of inorganic pigment from a coating composition.

The invention according to the third aspect may optionally include any of the optional features of the invention according to the first aspect or the second aspect.

It should be noted that the method of the invention can be applied to the recovery of TiO₂ in other compositions, in addition to the recovery of TiO₂ from coating compositions. Other compositions include, for example, toothpaste, cosmetics, and pharmaceuticals.

### DETAILED DESCRIPTION OF THE INVENTION

In order that the invention may be more clearly understood one or more embodiments thereof will now be described, by way of example only, with reference to the accompanying drawings, of which:

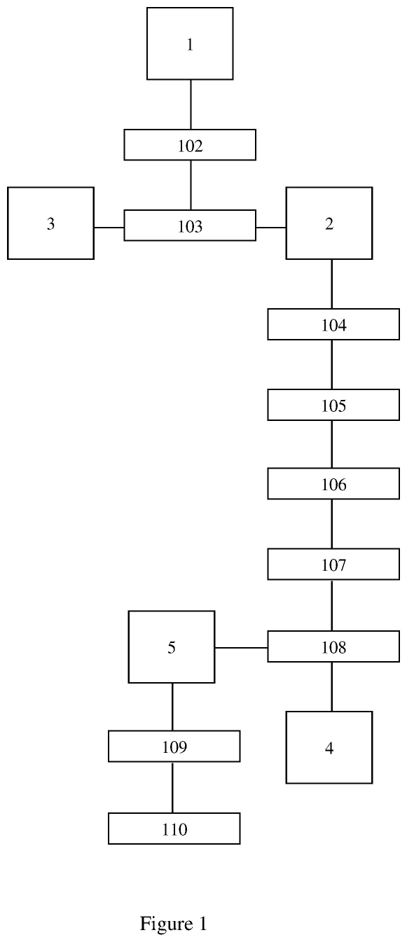

FIG. 1 is a schematic block diagram of a process according to an embodiment of the present invention.

Referring to FIG. 1, a coating composition 1 is initially selected. In this embodiment, the coating composition 1 is waste liquid waterborne paint. The composition of the coating composition 1 is approx. 45% w/w water: approx. 10% w/w TiO₂: approx. 30% w/w clay and talc: approx. 5% w/w calcium carbonate: approx. 10% w/w resin latex: also minor amounts of additives and stabilisers.

At step 102, approximately 200 g of the coating composition 1 is diluted using deionised water to approximately 20% w/w coating composition to obtain a diluted coating composition.

At step 103, the diluted coating composition is washed by centrifugation for 30 mins at relative centrifugal force (RCF) 4,500. The supernatant is decanted off and the wet sediment diluted with a similar volume of water as that the volume removed as supernatant, and redispersed by mixing: this is repeated 10 times. The washed coating composition is separated by centrifuging for 30 minutes at RCF 4,500 to obtain coating composition solids 2 and a supernatant 3. The supernatant 3 is separated from the coating composition solids 2 by decanting.

At step 104, the coating composition solids 2 is washed with acid solution to obtain an acid-washed coating composition. In this embodiment, the acid is hydrochloric acid in an amount of 0.4 mol/L. The acid-washed coating composition comprises acid-washed paint solids suspended in solution comprising residual acid and soluble chloride salt by reaction of hydrochloric acid with calcium carbonate. The acid-washed paint solids suspended in an acid/salt solution is continuously stirred for approximately 60 minutes. Step 104 removes any carbonates present in the coating composition solids 2. The hydrochloric acid converts the carbonates to carbon dioxide and water.

At step 105, the acid-washed coating composition is washed with deionised water by centrifugation. The acid-washed coating composition is washed with deionised water by centrifugation until the resultant supernatant has a conductivity of 15 μS, as measured by an electrical conductivity meter.

At step 106, the pH of the acid-washed coating composition (having a conductivity of 15 μS) is adjusted with an alkali solution until the composition has a pH of pH 7 and forms an acid-washed coating composition suspension. In this embodiment, the alkali solution is IM sodium hydroxide. In this embodiment, the alkali solution is added dropwise until the composition has a pH of pH 7.

At step 107, a polyethylene glycol (PEG) solution is added to the acid-washed coating composition suspension formed in step 106. In this embodiment, the PEG solution is supplied as DuPoint Polyox WSR 308. In this embodiment, the PEG solution comprises PEG having a molecular weight of 8,000,000 g/mol. In this embodiment, the PEG solution has a concentration of 1.6 g/L and is added to the acid-washed coating composition suspension so that the concentration of PEG in the acid-washed coating composition suspension is 0.016 g/L. The PEG solution is sufficient to effect flocculation of inorganic silicates (for example talc, clay and fillers) in the acid-washed coating composition suspension. Addition of PEG at step 107 provides a flocculated material 4 comprising inorganic silicates (for example talc, clay and fillers), and a suspension 5 comprising suspended inorganic pigment.

At step 108, the flocculated material 4 is separated from the suspension 5 by filtration using a sieve with pore size of 75 μm.

The flocculated material 4 can be washed of PEG using water and reused as an extender and/or filler in subsequent coating compositions.

At step 109, the suspension 5 (i.e., the filtrate from step 108) comprising suspended inorganic pigment is concentrated by centrifugation for 30 minutes at RCF 5000 to increase the solids content of the suspension 5 to approximately 50% w/w.

At step 110, the solids comprised in the suspension 5 are dried at 100° C. to obtain a recovered inorganic pigment. In this embodiment, the inorganic pigment comprises a significant amount of titanium dioxide, i.e. the recovered inorganic pigment comprises approximately 87% w/w titanium dioxide as determined by X-ray fluorescence.

The recovered inorganic pigment can be used as a source of inorganic pigment either as a sole source of inorganic pigment for a new coating composition or as one of multiple sources of inorganic pigment for a new coating composition.

### EXAMPLES

The pigment composition prepared as described above was analysed for elemental content (% by weight) by X-Ray Fluorescence (XRF) analysis as is shown in Table 1 (as ‘Recovered pigment (dried)’). An unused sample of a commercial pigmentary grade TiO₂ (Tiona 595) used in coatings applications was also analysed for elemental content by XRF analysis as is shown in Table 1. A sample of the washed coating composition solids 2 collected at step 103 was also analysed for elemental content by XRF analysis as is shown in Table 1. For comparison, a pigment composition acquired by conventional thermal treatment of a coating composition typically comprised approximately 30% w/w titanium.

TABLE 1

| | Elemental content | | | | | |
|---|---|---|---|---|---|---|
| | (wt %) | | | | | |
| Element | Ti | TiO₂ equivalent | Ca | Mg | Si | Al |
| Commercial TiO₂ | 54.73 | 92.20 | 0.44 | 0.48 | 0.60 | 1.73 |
| (Tiona 595) | | | | | | |
| Coating | 12.77 | 22.80 | 2.27 | 5.52 | 17.24 | 9.19 |
| composition | | | | | | |
| solids 2 | | | | | | |
| Recovered | 51.21 | 87.20 | 0.46 | 1.18 | 1.83 | 2.41 |
| pigment | | | | | | |
| (dried) | | | | | | |

As can be observed in the table above, it is notable and surprising that the method of the invention provides a recovered TiO₂ pigment of comparable elemental content to that of commercial grade TiO₂ pigment.

Notably, the method of the invention recovers a TiO₂ pigment composition with a considerably greater elemental content of titanium than a TiO₂ pigment composition recovered using conventional thermal treatment techniques (approximately 30% w/w titanium).

Moreover, the method of the invention does not require the high temperatures (at least 400° C.) used in thermal treatment techniques. As such, the method of the invention provides for a relatively cheap and easy method for recovering TiO₂, having a titanium elemental content comparable to that of commercial grade TiO₂, from coating compositions.

The one or more embodiments are described above by way of example only. Many variations are possible without departing from the scope of protection afforded by the appended claims.

We claim:

1. A method of recovering an inorganic pigment from a coating composition, the method comprising a step of:
a. adding polyethylene glycol to the coating composition,
wherein the polyethylene glycol has a molecular weight of between about 4,000,000and about 10,000,000 g/mol.

2. A method according to claim 1, wherein the method further comprises a step of washing the coating composition with an acid before step (a), to obtain an acid-washed coating composition.

3. A method according to claim 2, wherein the acid is hydrochloric acid, nitric acid, hydrobromic acid, hydroiodic acid, perchloric acid, chloric acid, sulphuric acid, hydrofluoric acid, or a mixture thereof.

4. A method according to claim 2, wherein the acid is present in an amount of between about 0.001 mol/L and about 10 mol/L of coating composition.

5. A method according to claim 2, wherein the step of washing the coating composition with acid is carried out at a temperature of between about 10 and about 100° C.

6. A method according to claim 2, wherein the step of washing the coating composition with acid is carried out under agitation of the coating composition and acid.

7. A method according to claim 2, wherein the method further comprises, before step (a), a step of washing the coating composition or the acid-washed coating composition with water by centrifuge or filtration until a supernatant or filtrate is obtained having a conductivity of less than 500 μS.

8. A method according to claim 2, wherein the method further comprises, before step (a), a step of adding an alkali solution to the coating composition or to the acid-washed coating composition to adjust the pH of the coating composition or the acid-washed coating composition to between pH 6 and 8, to form a coating composition suspension or an acid-washed coating composition suspension.

9. A method according to claim 1, wherein the method further comprises, before step (a), a step of initially diluting the coating composition with water to between about 99.9% and about 1% w/w based on the weight of the coating composition, to obtain a diluted coating composition.

10. A method according to claim 9, wherein the method further comprises, before step (a), a step of separating coating composition solids from the diluted coating composition by filtration and/or centrifugation to obtain coating composition solids and a supernatant and/or filtrate.

11. (canceled)

12. A method according to claim 1, wherein a suspension and a flocculated material are formed in step (a), and the method further comprises, after step (a):
b. separating the suspension from the flocculated material formed in step (a).

13. A method according to claim 12, wherein the suspension and the flocculated material are separated by filtration and/or centrifugation.

14. A method according to claim 12, wherein the method further comprises, after step (b):
c. concentrating the suspension to increase the solids content thereof.

15. A method according to claim 14, wherein the suspension is concentrated by filtration, centrifugation and/or evaporation to obtain a substantially solid inorganic pigment component.

16. A method according to claim 14, wherein the substantially solid inorganic pigment component is dried.

17. A method according to claim 12, wherein the suspension separated in step (b) comprises the inorganic pigment.

18. A method according to claim 1, wherein the polyethylene glycol is in the form of a solution having a polyethylene glycol concentration of between 0.001 and 2.0 g/L.

19. A method according to claim 1, wherein the inorganic pigment is titanium dioxide.

20. A method according to claim 1, wherein the coating composition is selected from the group comprising a paint, including water-borne paint and/or solvent-borne paint, a stain, a varnish, or an ink.

21. A coating composition comprising an inorganic pigment composition recovered according to claim 1.

22. (canceled)
